(19) United States
(12) Patent Application Publication
(10) Pub. No.: US 2006/0046029 A1
(43) Pub. Date: Mar. 2, 2006

(54) Embossed ornamental fabric and manufacturing method thereof

(75) Inventor: Byoung-Woo Cho, Yongin-city (KR)

Correspondence Address: STAAS & HALSEY LLP, SUITE 700, 1201 NEW YORK AVENUE, N.W., WASHINGTON, DC, 20005, US

(73) Assignee: Yupoong, Inc., Seoul (KR)

(21) Appl. No.: 10/923,746

(22) Filed: Aug. 24, 2004

(51) Int. Cl. B32B 3/00

(52) U.S. Cl. 428/156; 428/172

(57) ABSTRACT

An embossed ornamental fabric and a manufacturing method thereof are disclosed. A manufacturing method is performed by providing a base fabric, and a synthetic resin sheet on a rear side of the base fabric. The base fabric and the synthetic resin sheet are pressed with a shaping mold that has a predetermined design of an embossing or debossing pattern. The synthetic resin sheet has a predetermined thickness and is capable of being compressed according to the embossing or debossing pattern, so that the resultant fabric has the corresponding embossing or debossing pattern.

### BACKGROUND OF THE INVENTION

(a) Field of the Invention

The present invention relates to an embossed ornamental fabric and manufacturing method thereof, and more particularly to an embossed or debossed ornamental fabric that is applicable to ornaments of clothing, headwear, footwear, and so forth, and a manufacturing method thereof.

(b) Description of the Related Art

A conventional method of manufacturing an embossed ornamental fabric is illustrated in FIG. 5. A pair of shaping molds is comprised of an upper mold 10 and a lower mold 20. The upper mold 10 has a desired protruding shape, and a lower mold 20 is provided on the opposite side the upper mold and has a corresponding recessed shape. A fabric 30 is placed between the upper mold 10 and the lower mold 20 in step (a). Then the upper mold 10 is pressed down with a predetermined heat, to form an embossed shape 31 on the fabric in step (b). Then, a liquid filler 40, such as silicone, is filled into the rear portion of the embossed shape 31 and then hardened to retain the embossed shape 31 on the fabric 30 in step (c).

The conventional method has several drawbacks in that the silicone filling and hardening processes are difficult to perform and require an expensive filling apparatus, resulting in increased product cost and low productivity. Further, the embossed fabric according to the conventional method has only a single-surfaced embossed pattern, since the silicone filler is filled into the rear portion of the embossed portion. Therefore, the conventional method has not met various design needs, which require a double-surface embossed ornamental fabric.

### SUMMARY OF THE INVENTION

In view of the prior art described above, it is an object of the present invention to provide a manufacturing method of an embossed ornamental fabric with low cost and high productivity.

It is another object of the present invention to provide an embossed ornamental fabric that is capable of being manufactured by a relatively simple manufacturing process.

It is still another object of the present invention to provide a double-surface embossed ornamental fabric that is capable of being manufactured by a relatively simple manufacturing process.

To achieve these and other objects, as embodied and broadly described herein, a manufacturing method of an embossed ornamental fabric includes:
providing a base fabric;
providing a synthetic resin sheet on a rear side of the base fabric; and
pressing on a front side of the base fabric, along with the synthetic resin sheet, with a shaping mold that has a predetermined design of embossing or debossing pattern. The synthetic resin sheet has a predetermined thickness and is capable of being compressed according to the embossing or debossing pattern, so that a resultant fabric with the embossing or debossing pattern is formed.

According to another aspect of the present invention, an embossed ornamental fabric includes:
providing a rear fabric, a synthetic resin sheet and a base fabric; and
pressing the base fabric, the synthetic resin sheet, and the rear fabric on both surfaces with shaping molds which have a predetermined design of embossing or debossing pattern. The synthetic resin sheet has a predetermined thickness and is capable of being compressed according to the embossing or debossing pattern, so that a resultant fabric is formed with a double surfaced embossing or debossing pattern.

According to another aspect of the present invention, an embossed ornamental fabric includes a base fabric being selected from a non-woven fabric, woven fabric, or knitted fabric; and a synthetic resin sheet adhered to a rear side of the base fabric. The synthetic resin sheet has a predetermined thickness and is capable of being compressed according to a desired embossing or debossing pattern, thereby resulting in an ornamental fabric with the embossing or debossing pattern.

The embossed ornamental fabric preferably has a rear fabric adhered to the synthetic resin sheet. The synthetic resin sheet is compressed on both surfaces according to the desired embossing or debossing pattern, so that the resultant ornamental fabric has a double surfaced embossing pattern.

### BRIEF DESCRIPTION OF THE DRAWINGS

The accompanying drawings, which are incorporated in and constitute a part of the specification, illustrate an embodiment of the invention, and, together with the description, serve to explain the principles of the invention.

FIG. 1 illustrates steps of a manufacturing method of an embossed ornamental fabric according to a first embodiment of the present invention;

FIG. 2 is a schematic cross-sectional view showing an example of the apparatus for producing the embossed ornamental fabric of the present invention;

FIG. 3 illustrates another example of the method according to the first embodiment of the present invention;

FIG. 4 illustrates steps of a manufacturing method of an embossed ornamental fabric according to a second embodiment of the present invention; and

FIG. 5 illustrates steps of a conventional manufacturing method of an embossed fabric.

### DETAILED DESCRIPTION OF THE PREFERRED EMBODIMENTS

Preferred embodiments of the present invention will hereinafter be described in detail with reference to the accompanying drawings, where like reference numerals designate like elements throughout.

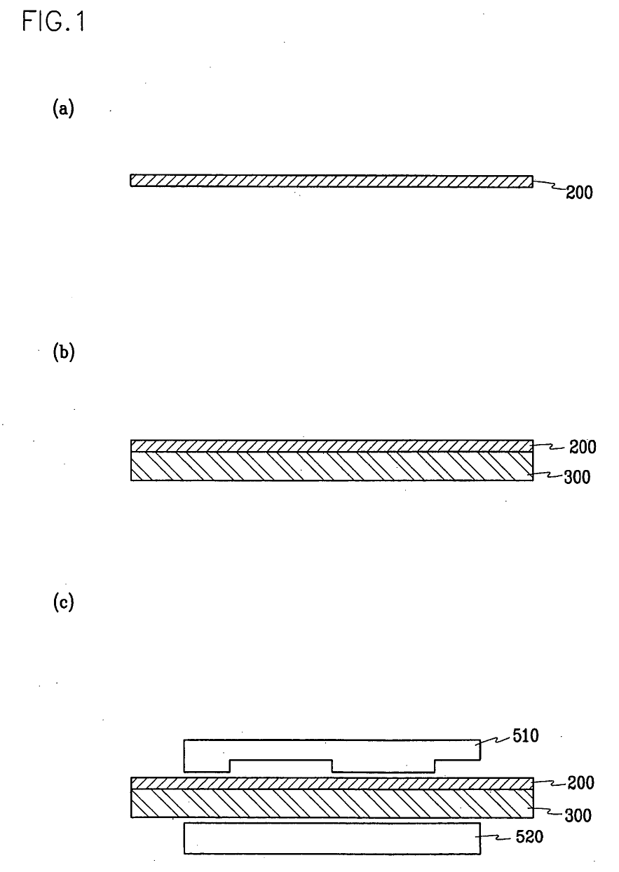

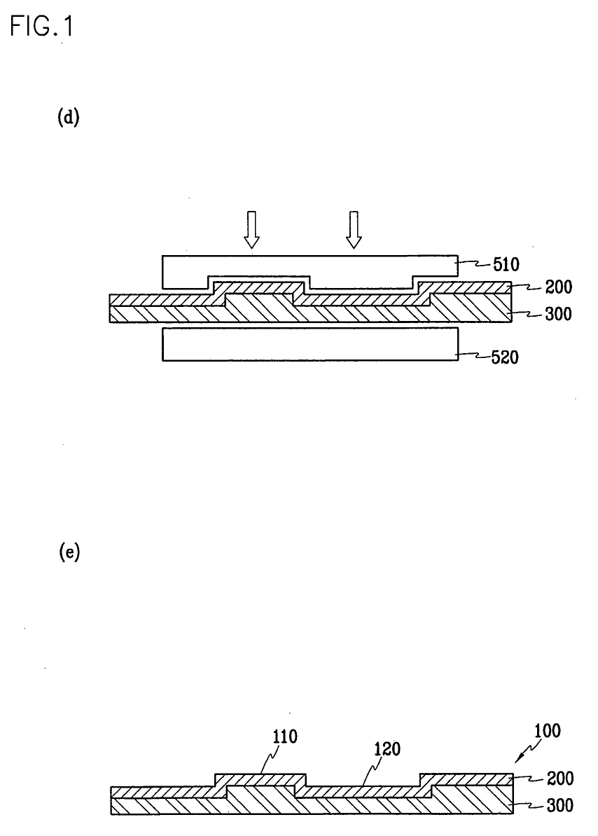

Referring to FIG. 1, a manufacturing method of an embossed ornamental fabric according to a first embodiment of the present invention is illustrated.

Creation of the embossed ornamental fabric begins by placing a base fabric 200 and a synthetic resin sheet 300 in steps (a) and (b). The synthetic resin sheet 300 is placed in contact with the rear side of the base fabric 200. The base fabric 200 may be selected from any kind of fabric that is a non-woven fabric, woven fabric, or knitted fabric.

The material of the synthetic resin sheet 300 is preferably selected from polyethylene (PE), polyethylene terephthalate (PET), ethylene vinyl acetate (EVA), polystyrene (PS), and so forth, which are capable of being reduced in volume under an appropriate pressure and/or heat. The synthetic resin sheet 300 may be formed in a foam type, in which a plurality of fine pores reside. The synthetic resin sheet 300 has a predetermined thickness in order to be compressed in volume by pressure and/or heat.

The basic fabric 200 and the synthetic resin sheet 300 are placed between a pair of molds 510 and 520 in step (c) and then pressed by the molds 510 and 520 in step (d). The molds 510 and 520 have predetermined designs of embossing or debossing pattern, which have protruding parts or recessed parts. An ornamental fabric 100 is then formed with an embossing part 110 and debossing part 120, according to the shape of mold 510, in step (e) of FIG. 1.

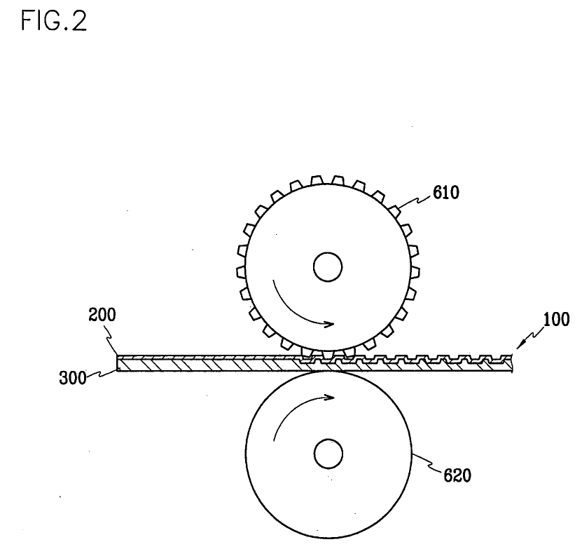

The molds 510 and 520 may be attached to a press machine. Alternatively, they may be substituted with a pair of rolls 610 and 620 as shown in FIG. 2. The roll 610 is an emboss roll according to the predetermined design of embossing or debossing pattern.

The base fabric 200 and the synthetic resin sheet 300 may be adhered together by applying a suitable adhesive therebetween in step (a) or (b).

When the mold 510 of FIG. 1 or roll 610 of FIG. 2 has a heater therein, heat is applied during the pressing step (d) as shown in FIG. 1. In the case of appropriate material of the synthetic resin, the heat applied may slightly melt the surface of the synthetic resin sheet 300 facing the base fabric 200. After the pressing step, in which the pressure and heat are applied, the surface of the synthetic resin sheet 300 cools to adhere to the base fabric.

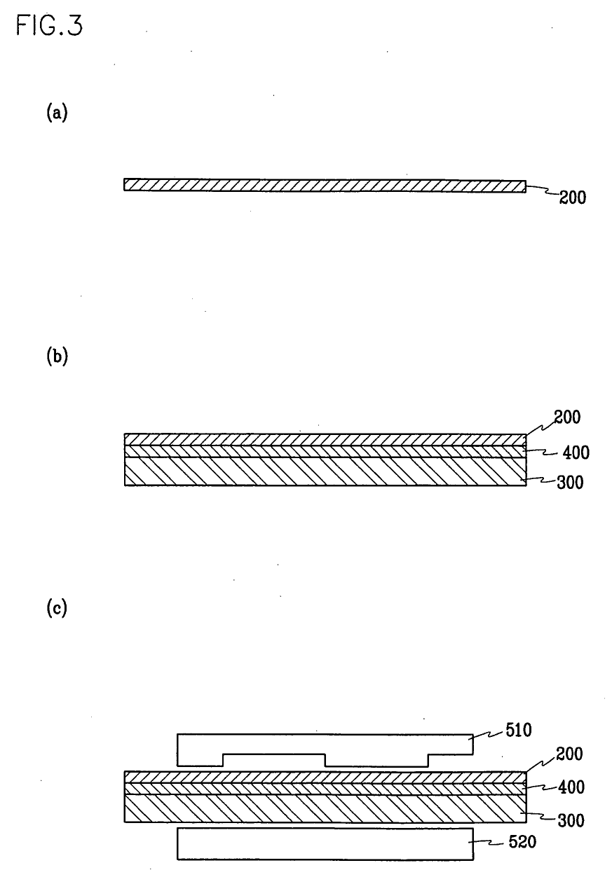

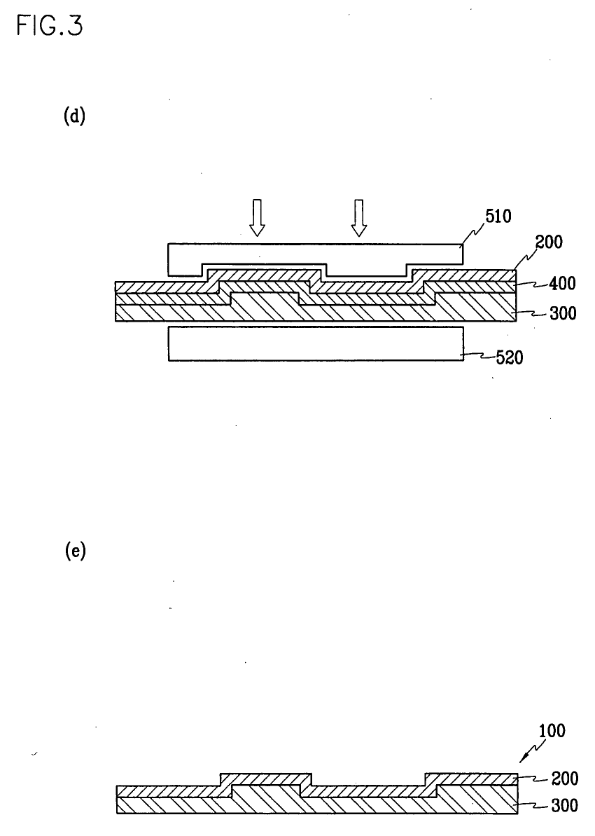

It is also possible to provide a thermal adhesive sheet between the base fabric and the synthetic resin sheet in order to adhere them to each other. Referring to FIG. 3, a thermal adhesive sheet 400 is provided between a base fabric 200 and a synthetic resin sheet 300 in steps (a) and (b).

The base fabric 200, the thermal-adhesive sheet 400, and the synthetic resin sheet 300 are placed between a pair of molds 510 and 520 in step (c). At least one of the molds 510 and 520 has a heater therein. It should be noted that the molds 510 and 520 may be substituted with appropriate rolls as similar to FIG. 2. Then, the molds 510 and 520 press the base fabric 200 and the synthetic resin sheet 300 to form a desired embossing or debossing pattern thereon in step (d). The heat applied by the molds 510 and/or 520 also melts the thermal adhesive sheet 400 to adhere the base fabric 200 to the synthetic resin sheet 300 in step (d). An ornamental fabric 100 has the desired embossing or debossing pattern in step (e).

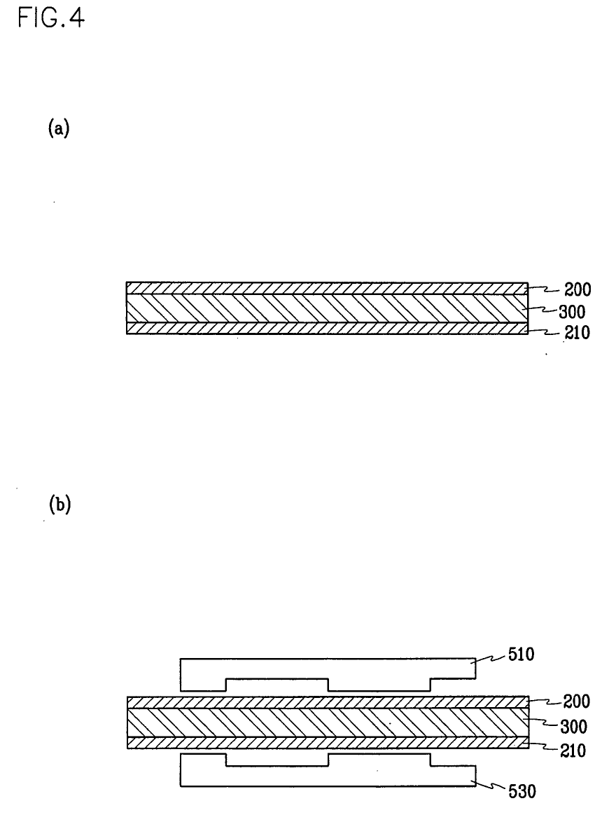

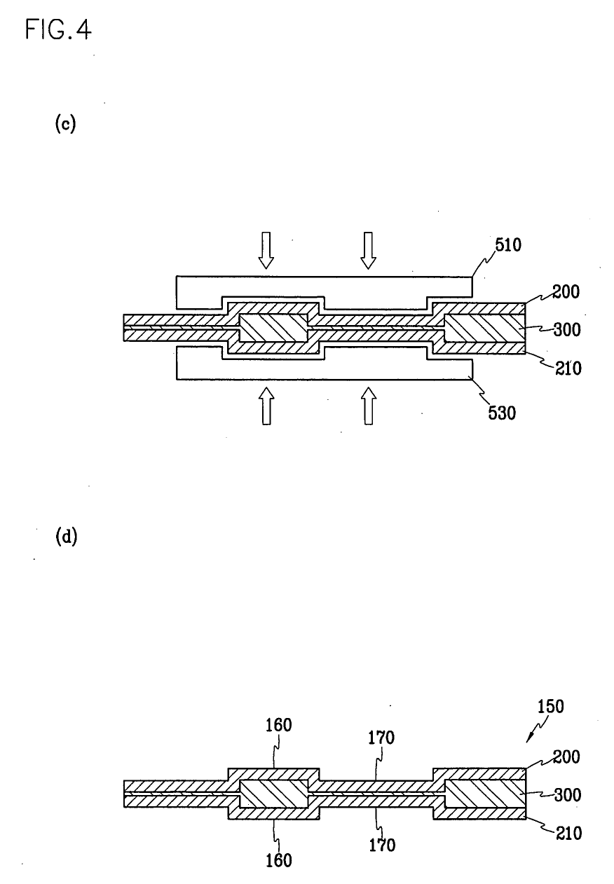

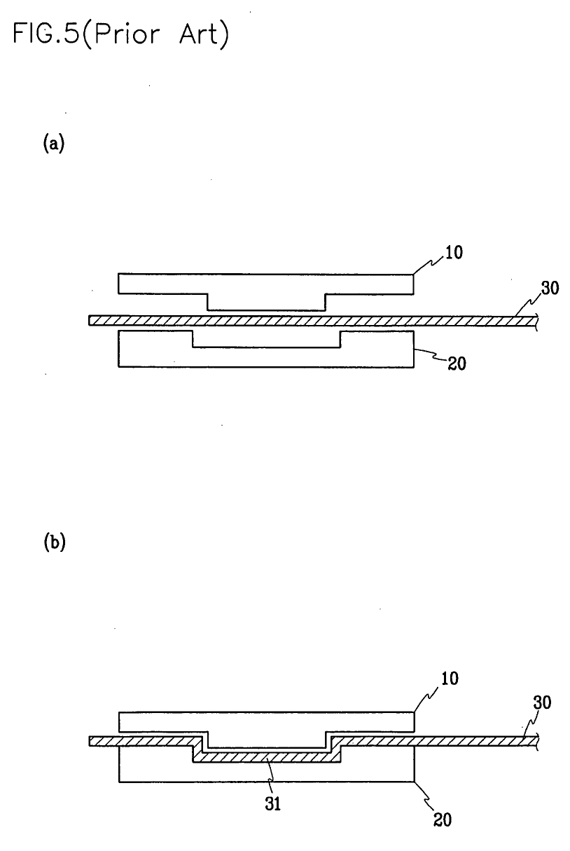

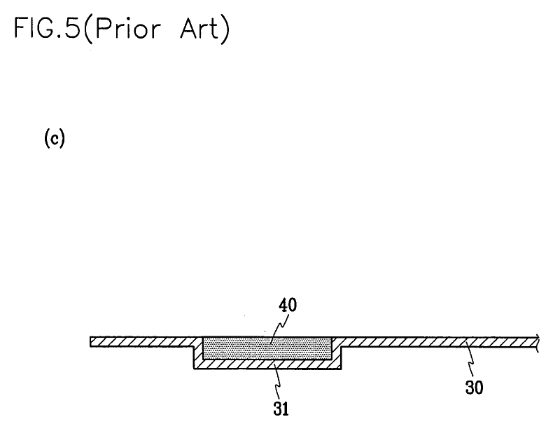

Referring now to FIG. 4, a manufacturing method of an embossed ornamental fabric according to a second embodiment of the present invention is illustrated. The second embodiment is directed to a double-surfaced ornamental fabric.

A base fabric 200, a synthetic resin sheet 300 and a rear fabric 210 are provided in step (a). The synthetic resin sheet 300 is placed in contact between the base fabric 200 and the rear fabric 210. The base fabric 200 and the rear fabric 210 may be selected from any kind of fabric that is a non-woven fabric, woven fabric, or knitted fabric.

The material of the synthetic resin sheet 300 is preferably selected from PE, PET, EVA, or PS, similar to that of the first embodiment. The synthetic resin sheet 300 has a predetermined thickness in order to be compressed in volume by pressure and/or heat.

The base fabric 200, the synthetic resin sheet 300, and the rear fabric 210 are placed between a pair of molds 510 and 530 in step (b) and then pressed by the molds 510 and 530 in step (c). The molds 510 and 530 have predetermined designs of embossing or debossing patterns, which have protruding parts or recessed parts. Similar to the first embodiment, the molds 510 and 530 may be substituted with a pair of embossing rolls, although in the drawing this is not shown.

A double-surfaced ornamental fabric 150 is then formed with embossing parts 160 and debossing parts 170 on either surface thereof according to the shape of molds 510 and 530.

The synthetic resin sheet 300 may be adhered to the base fabric 200 and the rear fabric 210 by applying a suitable adhesive therebetween in step (a), similar to the first embodiment. Alternatively, two thermal adhesive sheets are used in order to laminate the base fabric 200, the synthetic resin sheet 300, and rear fabric 210 with hot molds or hot rolls, which provide appropriate heat as well as pressure. In the case of an appropriate material of the synthetic resin, the heat applied may slightly melt both surfaces of the synthetic resin sheet 300 in order to adhere it to the base fabric and the rear fabric.

As described above, the method according to the present invention has advantages in that simple processing steps are required to form an embossed ornamental fabric using a general press machine or rolls. Further, the method according to the present invention is capable of forming a double-surfaced ornamental fabric in simple processing steps.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A manufacturing method of an embossed or debossed ornamental fabric, comprising:
providing a base fabric;
providing a synthetic resin sheet on a rear side of the base fabric, the synthetic resin sheet having a predetermined thickness; and
pressing on a front side of the base fabric along with the synthetic resin sheet with a shaping mold which has a predetermined design of embossing or debossing pattern, the synthetic resin sheet being compressed according to the embossing or debossing pattern, thereby resulting in an ornamental fabric with the embossing or debossing pattern.

2. The method of claim 1, wherein the material of the synthetic resin sheet is selected from polyethylene (PE), polyethylene terephthalate (PET), ethylene vinyl acetate (EVA), or polystyrene (PS), which are capable of being reduced in volume under an appropriate pressure or heat.

3. The method of claim 1, wherein the base fabric is selected from a non-woven fabric, woven fabric, or knitted fabric.

4. The method of claim 1, wherein heat is applied to the base fabric and the synthetic resin sheet during pressing of the base fabric and the synthetic resin sheet.

5. The method of claim 4, wherein the synthetic resin sheet is adhered to the base fabric by the pressure and heat applied.

6. The method of claim 4, further comprising:
providing a thermal adhesive sheet between the base fabric and the synthetic resin sheet before pressing, the thermal adhesive sheet being melted to adhere the synthetic resin sheet to the base fabric by the heat applied.

7. The method of claim 1, further comprising:
applying an adhesive between the base fabric and the synthetic resin sheet before pressing.

8. A manufacturing method of an embossed or debossed ornamental fabric, comprising:
providing a rear fabric;
providing a synthetic resin sheet on the rear fabric, the synthetic resin sheet having a predetermined thickness;
providing a base fabric on the synthetic resin sheet; and
pressing the base fabric and the rear fabric on both sides with shaping molds which have a predetermined design of an embossing or debossing pattern, the synthetic resin sheet being compressed according to the embossing or debossing pattern, thereby resulting in a double-surfaced ornamental fabric with the embossing or debossing pattern.

9. The method of claim 8, wherein heat is applied to both sides of the synthetic resin sheet during pressing.

10. The method of claim 9, wherein the synthetic resin sheet is adhered to the base fabric as well as the rear fabric by the pressure and heat applied.

11. The method of claim 9, further comprising:
providing a first thermal adhesive sheet between the base fabric and the synthetic resin sheet, and
providing a second thermal adhesive sheet between the rear fabric and the synthetic resin sheet before pressing,
wherein the first thermal adhesive sheet is melted to adhere the synthetic resin sheet to the base fabric and the second thermal adhesive sheet is melted to adhere the synthetic resin sheet to the rear fabric by the heat applied.

12. The method of claim 8, further comprising:
applying an adhesive between the base fabric and the synthetic resin sheet; and
applying an adhesive between the rear fabric and the synthetic resin sheet before pressing.

13. An ornamental fabric having at least one embossing or debossing pattern, comprising:
a base fabric being selected from a non-woven fabric, woven fabric, or knitted fabric; and
a synthetic resin sheet adhered to a rear side of the base fabric, having a predetermined thickness, the synthetic resin being compressed according to a desired embossing or debossing pattern, thereby resulting in an ornamental fabric with the embossing or debossing pattern.

14. The fabric of claim 13, wherein the material of the synthetic resin sheet is selected from polyethylene (PE), polyethylene terephthalate (PET), ethylene vinyl acetate (EVA), or polystyrene (PS), which are capable of being reduced in volume under an appropriate pressure or heat.

15. The fabric of claim 13, further comprising:
a rear fabric adhered to the synthetic resin sheet,
wherein the synthetic resin sheet is compressed on both sides according to the desired embossing or debossing pattern, thereby resulting in a double-surfaced embossed ornamental fabric.
